(19) United States
(12) Patent Application Publication
(10) Pub. No.: US 2018/0046691 A1
(43) Pub. Date: Feb. 15, 2018

(54) QUERY GOVERNOR RULES FOR DATA REPLICATION

(71) Applicant: International Business Machines Corporation, Armonk, NY (US)

(72) Inventors: Eric L. BARSNESS, Pine Island, MN (US); Daniel E. BEUCH, Rochester, MN (US); Brian R. MURAS, Otsego, MN (US); John M. SANTOSUOSSO, Rochester, MN (US)

(21) Appl. No.: 15/233,678

(22) Filed: Aug. 10, 2016

(51) Int. Cl. G06F 17/30; G06F 11/14

(52) U.S. Cl. CPC G06F 17/30575; G06F 17/30477; G06F 11/1402; G06F 2201/80

(57) ABSTRACT

Embodiments of the present disclosure provide a method, system, and computer program product for managing the execution of a query. The method, system and computer program product include receiving a query to be executed. The query governor calculates an estimated replication time of the received query. The estimated replication time is an estimated duration of time required to replicate changes caused by the query. The query governor determines whether the estimated replication time exceeds the threshold replication time. Responsive to the query governor determining that the estimated replication time does not exceed the threshold replication time, the query governor executes the query against the database in accordance with the instructions.

### BACKGROUND

The present application generally relates to database management, and more particularly, to managing query execution based on a replication time.

### DESCRIPTION OF THE RELATED ART

Databases are computerized data storage and retrieval systems. A relational database management system is a computer database management system (DBMS) that uses relational techniques for storing and retrieving data. An object-oriented programming database is a database that is congruent with the data defined in object classes and subclasses.

Regardless of the particular architecture, a requesting entity (e.g., an application or the operating system) in a DBMS requests access to a specified database by issuing a database access request. Such requests may include, for instance, simple catalog lookup requests or transactions and combinations of transactions that operate to read, change, and add specified records in the database. These requests (i.e., queries) are often made using high-level query languages such as the Structured Query Language (SQL). Upon receiving such a request, the DBMS may execute the request against a corresponding database, and return any result of the execution to the requesting entity.

### SUMMARY

Embodiments of the present disclosure provide a method, system, and computer program product for managing the execution of a query. The method, system and computer program product include receiving a query to be executed. The query governor calculates an estimated replication time of the received query. The estimated replication time is an estimated duration of time required to replicate changes caused by the query. The query governor determines whether the estimated replication time exceeds the threshold replication time. Responsive to the query governor determining that the estimated replication time does not exceed the threshold replication time, the query governor executes the query against the database in accordance with the instructions.

### BRIEF DESCRIPTION OF THE DRAWINGS

So that the manner in which the above recited aspects are attained and can be understood in detail, a more particular description of embodiments of the present disclosure, briefly summarized above, may be had by reference to the appended drawings.

It is to be noted, however, that the appended drawings illustrate only typical embodiments of this invention and are therefore not to be considered limiting of its scope, for the present disclosure may admit to other equally effective embodiments.

FIG. 1A-1B are block diagrams illustrating a networked system for managing query processing, according to embodiments of the present disclosure.

FIG. 2A is a flow diagram illustrating a method of managing query execution, according to one embodiment of the present disclosure.

FIG. 2B is a flow diagram illustrating a method of managing query execution, according to one embodiment of the present disclosure.

FIG. 3 is a flow diagram illustrating a method of managing query execution, according to one embodiment of the present disclosure.

FIG. 4 is a flow diagram illustrating a method of managing query execution, according to one embodiment of the present disclosure.

FIG. 5 is a flow diagram illustrating a method of managing query execution, according to one embodiment of the present disclosure.

FIG. 6 is a block diagram illustrating a computer memory of the query governor system of FIGS. 1A-1B, according to one embodiment of the present disclosure

### DETAILED DESCRIPTION

Many DBMS include some form of query governor, which generally controls how long queries may execute. For example, a query governor may enable a database administrator to have queries time out (i.e., execution of the query is halted) if a predetermined amount of time elapses before the execution completes. Such functionality enables the DBMS to prevent a single query from tying up the DBMS' resources for an excessive period of time.

Embodiments described herein provide techniques for managing query execution based on an estimated replication time to update the data changes resulting from execution of the query. For example, before the database executes the query, a query governor for the DBMS could calculate an estimated amount of data to be changed by the query and communicate the amount of data to be changed to a replication agent in a replication agent. The replication agent may calculate an estimated replication time to replicate the changes made by the query to a database hosted by the replication agent, and if the estimated replication time exceeds a threshold value, the replication agent may communicate with the query governor to reject the query. Continuing this example, if the replication agent determines the estimated replication time is less than or equal to the threshold amount, the replication agent may communicate with the query governor to submit the query to the database for execution.

In addition to limiting queries based on an estimated replication time, a replication agent may wish to modify the query such that the executing the query results in a shorter replication time. For example, the replication agent may recognize the operations of the received query, and change the received query to a modified query that achieves the same end result of the received query, but results in a shorter replication time. In a particular example, the replication agent may receive a query in the form of a DELETE statement having a first estimated replication time and equate the DELETE statement to a TRUNCATE statement having a second estimated replication time, wherein the first estimated replication time is longer than the second estimated replication time.

Alternatively, a replication agent may wish to delay processing of the query, such that queries having shorter replication times may take precedent. For example, the replication agent may estimate a replication time of a received query and compare the replication time to a first threshold value. Rather than rejecting the query altogether if the replication time exceeds the first threshold value, the replication agent may compare the replication time to a second threshold value. If the replication time exceeds the first threshold value, but not the second threshold value, the replication agent may communicate with the query governor to delay processing of the received query. This allows queries having shorter replication times, i.e. replication times less that the first threshold value, to take precedence over longer replication times.

Embodiments of the present disclosure generally receives a query to be executed against a database. The query governor calculates the estimated replication time of the received query. The estimated replication time is an estimated duration of time required to replicate changes caused by the query. The query governor determines whether the estimated replication time exceeds a threshold replication time. The query governor executes the query against the database in accordance with the instructions responsive to determine that the estimated replication time does not exceed the threshold replication time.

In the following, reference is made to embodiments of the present disclosure. However, it should be understood that the present disclosure is not limited to specific described embodiments. Instead, any combination of the following features and elements, whether related to different embodiments or not, is contemplated to implement and practice the present disclosure. Furthermore, although embodiments of the present disclosure may achieve advantages over other possible solutions and/or over the prior art, whether or not a particular advantage is achieved by a given embodiment is not limiting of the present disclosure. Thus, the following aspects, features, embodiments, and advantages are merely illustrative and are not considered elements or limitations of the appended claims except where explicitly recited in a claim(s). Likewise, reference to “the present disclosure” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the present disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the DBMS) available in the cloud. For example, the DBMS could execute on a computing system in the cloud and receive user requests (e.g., queries) to access databases managed by the DBMS. In such a case, a query governor may calculate an estimated amount of data change for a received request, and then determine whether to submit the query to the DBMS for execution based on the estimated amount of data. Doing so allows a user to access the database data from any computing system attached to a network connected to the cloud (e.g., the Internet).

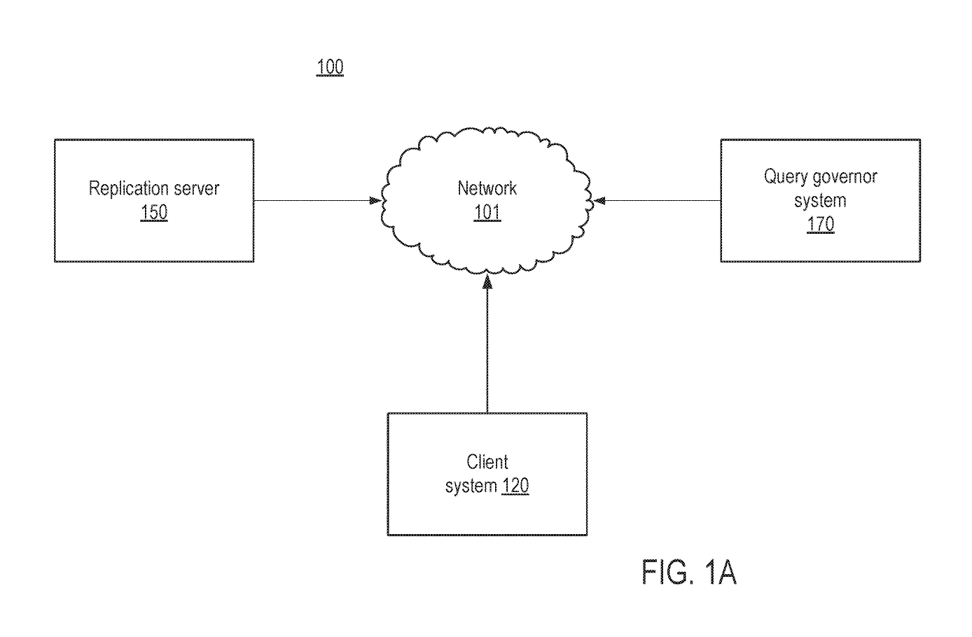

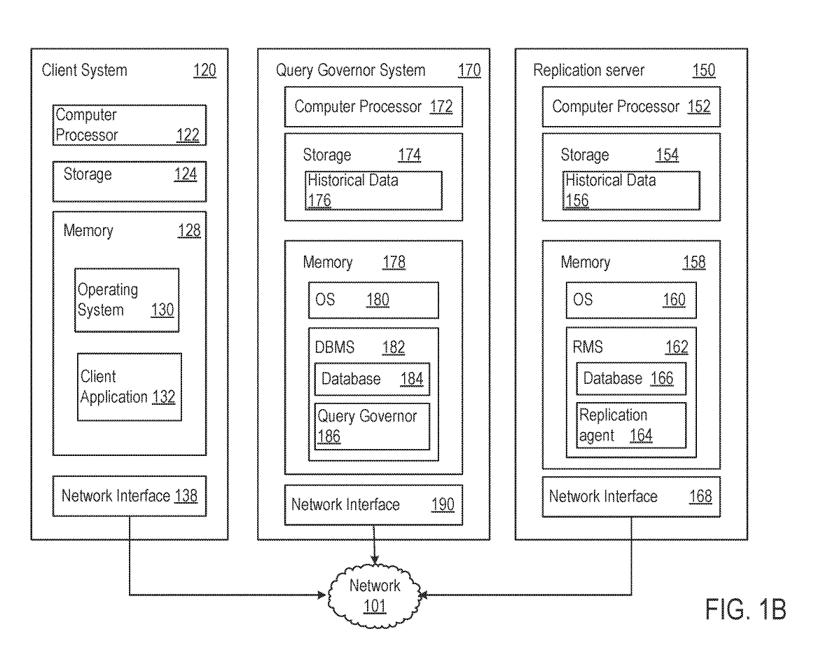

FIG. 1A-1B are block diagrams illustrating a networked system for managing query processing, according to embodiments of the present disclosure. As shown, FIG. 1A is a block diagram illustrating a networked system for managing query processing, according to one embodiment of the present disclosure. In the depicted embodiment, the system 100 includes a client system 120, a replication agent 150, and a database server 170, connected by a network 101. Generally, the client system 120 may submit requests (i.e., queries) over the network 101 to a DBMS running on the database server 170. The term “query” specifies a set of commands for retrieving data from a database. Queries may take the form of a command language, such as the Structured Query Language (SQL), and enable programmers and programs to access data within the database. For instance, queries can be used to select, insert, update, find out the location of data, and so forth. Generally speaking, any requesting entity can issue queries against data in a database. For example, software applications (such as by an application running on the client system 120), and operating systems may submit queries to the database. These queries may be predefined (i.e., hard coded as part of an application) or may be generated in response to input (e.g., user input). Upon receiving the request, the DBMS on the database server 170 may execute the request against a database specified in the request, and then return the result of the executed request.

When the query is executed against a database in the client system 120, the query may change or update data in the database in the client system 120. The replication agent 150 copies (i.e., replicates) the data changes of the database in the client system 120 to a database hosted in the replication agent 150. This allows remote users to access the database hosted in the replication agent 150 without interfering with, or editing, the data in the database in the client system 120.

However, it may be desirable for the database server 170 to only process certain requests it receives. That is, if a particular request would change an excessive amount of data that results in an excessive replication time, the database server 170 may wish to reject this query. According to embodiments of the present disclosure, the database server 170 may include a query governor configured to communicate with a replication agent in the replication agent 150 to determine which received requests the DBMS should execute. In one embodiment of the present disclosure, upon receiving a query from the client system 120, the query governor may calculate an estimated amount of data change for the query. The query governor communicates the estimated amount of data change with the replication agent. The query governor may receive from the replication agent instructions to modify or reject the query based on determining that an estimated replication time for the amount of data change exceeds a threshold amount. For example, assume that the estimated replication time for changing 10,000 rows of data will take 5 hours, which exceeds a threshold amount of 2 hours. The query governor may adjust the query in response to the estimated replication time. The query governor may execute a modified query against the database. Furthermore, if the estimated replication time does not exceed a threshold value, then the query governor receives from the replication agent an allowance to run the query, and the query governor may submit the query to the DBMS for processing. In some embodiments, once the processing of the query has begun, the query governor may periodically calculate an updated estimated amount of data change for the query, communicate the updated estimated amount of data change for the query to the replication agent, and receive an updated estimated replication time from the replication agent.

Referring now to FIG. 1B, FIG. 1B is a block diagram of a networked computer system configured to calculate an estimated replication time for query processing, according to one embodiment of the present disclosure. As shown, the system 110 contains a client system 120, a replication agent 150, and a database server 170. The client system 120 contains a computer processor 122, storage media 124, memory 128, and a network interface 138. Computer processor 122 may be any processor capable of performing the functions described herein. The client system 120 may connect to the network 101 using the network interface 138. Furthermore, as will be understood by one of ordinary skill in the art, any computer system capable of performing the functions described herein may be used.

In the pictured embodiment, memory 128 contains an operating system 130 and a client application 132. Although memory 128 is shown as a single entity, memory 128 may include one or more memory devices having blocks of memory associated with physical addresses, such as random access memory (RAM), read only memory (ROM), flash memory or other types of volatile and/or non-volatile memory. The client application 132 is generally capable of generating database queries. Once the client application 132 generates a query, the query may be submitted over the network 101 to a DBMS (e.g., DBMS 182) for execution. The operating system 130 may be any operating system capable of performing the functions described herein.

The database server 170 contains a computer processor 172, storage media 174, memory 178, and a network interface 190. Computer processor 172 may be any processor capable of performing the functions described herein. Storage media 174 contains historical data 176. The historical data 176 may include data and metadata describing previously executed queries. For example, in one embodiment of the present disclosure, the historical data 176 includes data about the amount of data changed from previously executed queries. The database server 170 may connect to the network 101 using the network interface 190. Furthermore, as will be understood by one of ordinary skill in the art, any computer system capable of performing the functions described herein may be used.

In the pictured embodiment, memory 178 contains an operating system 180 and a DBMS 182. Although memory 178 is shown as a single entity, memory 178 may include one or more memory devices having blocks of memory associated with physical addresses, such as random access memory (RAM), read only memory (ROM), flash memory or other types of volatile and/or non-volatile memory. The DBMS 182 contains a database 184 and a query governor 186. The operating system 180 may be any operating system capable of performing the functions described herein.

The replication agent 150 contains a computer processor 152, storage media 154, memory 158, and a network interface 168. Computer processor 152 may be any processor capable of performing the functions described herein. Storage media 154 contains historical data 156. The historical data 156 may include data and metadata describing replication run times from the previously executed queries. The replication agent 150 may connect to the network 101 using the network interface 168. Furthermore, as will be understood by one of ordinary skill in the art, any computer system capable of performing the functions described herein may be used.

In the pictured embodiment, memory 158 includes an operating system 160 and a replication management system 162. Although memory 158 is shown as a single entity, memory 178 may include one or more memory devices having blocks of memory associated with physical addresses, such as RAM, ROM, flash memory or other types of volatile and/or non-volatile memory. The replication management system 162 includes a replication agent 164 and a database 166. The operating system 160 may be any operating system capable of performing the functions described herein.

Generally, the client application 132 may generate and submit queries to the DBMS 182 using the network 101. According to embodiments of the present disclosure, once the DBMS 182 receives a query, the query governor 186 may calculate an estimated amount of data change for the query. For example, the estimated amount of data change may include a number of bytes of information changed or updated in a database. In another example, the estimated amount of data change may include a percentage of the information changed or updated in the database. In yet another example, the estimated amount of data change may include a number of rows of information in the database that is updated. Such a calculation may be based on values in the received query. In one embodiment, the estimated amount of data change corresponds to the amount of data change that needs to be replicated. In other words, the query governor only calculates the amount of data change for those updates that need to be replicated, i.e. not all updates in a query need to be replicated. The DBMS 182 communicates the estimated amount of data change for the query to the replication management system 162 in the replication agent 150. The replication management system 162 is configured to copy, or replicate, the changes to the database 166. The replication agent 164 is configured to calculate an estimated replication time based on the estimated amount of data change calculated by the query governor. The estimated replication time is the amount of time it will take to replicate the changes made to the database by the query.

Of course, the above examples are merely for illustrative purposes, and one of ordinary skill in the art will recognize that other data, metadata and historical data, as well as combinations there between, may be used as well.

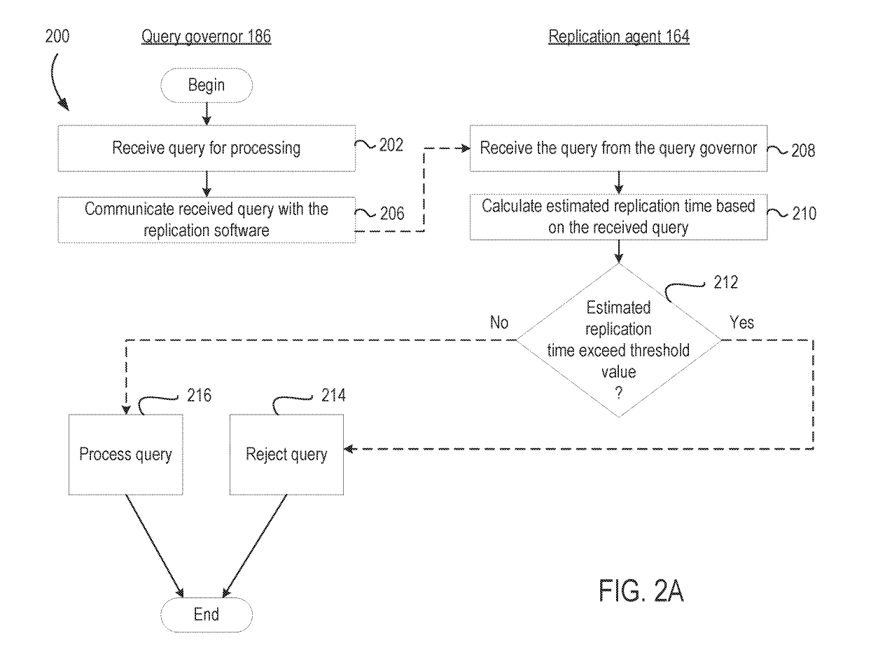

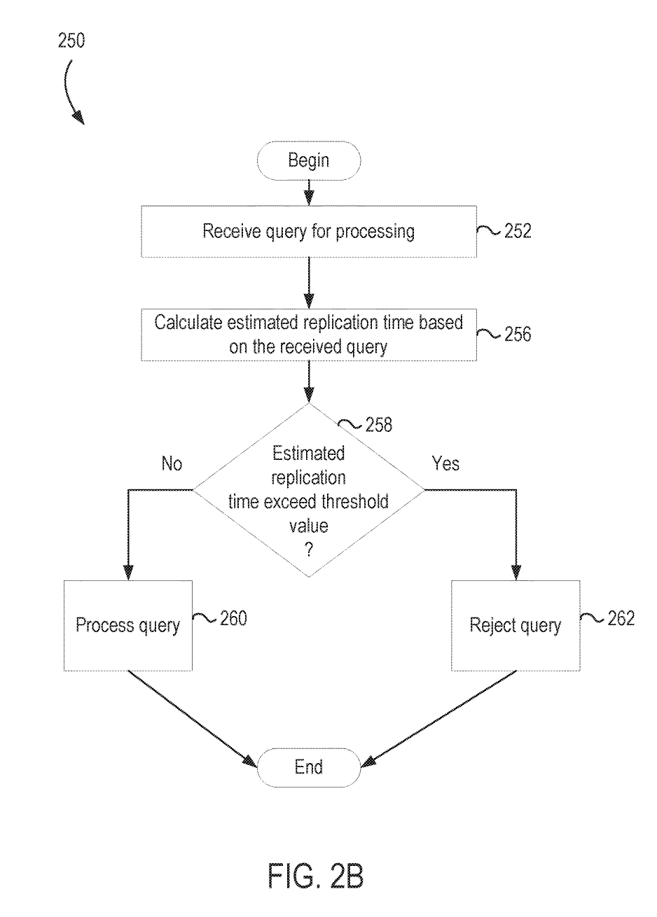

FIG. 2 is a flow diagram illustrating a method of managing query execution, according to one embodiment of the present disclosure. As shown, the method 200 begins at step 202, where the query governor 186 receives a query for processing. Upon receiving the query, the query governor 186 communicates the received query with the replication agent 150 (step 206) calculates an estimated amount of data change for executing the received query (step 204).

The query governor 186 communicates with the replication agent 150 over network 101. The replication agent 150 receives the received query from the query governor 186 (step 208). The replication agent 164 in the replication agent 150 calculates an estimated replication time for the received query (step 210). In one embodiment, calculating an estimated replication time includes calculating an estimated amount of data change for executing the received query. The estimated amount of data change may be determined by calculating an estimated amount of rows to be changed by the query execution. In another embodiment, calculating an estimated amount of data change for executing the received query includes calculating an estimated amount of bytes of data to be changed by the query execution. In yet another embodiment, calculating an estimated amount of data change for executing the received query for executing the received query includes calculating a percentage amount of data, such as a percentage of the number of rows in a table or the percentage of information in a given database, to be changed by the query execution.

In another embodiment, calculating an estimated replication time for replicating the data changes of received query includes calculating an estimated replication time based on the type of data change. For example, the replication agent 164 may determine that 50 DELETE statements have a shorter replication time than 50 UPDATE statements. In another embodiment, calculating an estimated replication time for replicating the data changes of the received query includes calculating an estimated replication time based on historical data relating to that query. For example, the replication agent 164 may determine that a DELETE statement takes X seconds to delete five rows of data. The replication agent 164 may extrapolate that historical data to estimate the replication time for a DELETE statement updating 500 rows of data.

The replication agent 164 then determines whether the estimated amount replication time for the received query exceeds a threshold value of replication time (step 212). The threshold value of replication may include, for example, the replication duration, the state of the network between the database and the replication agents, available network, and other external factors that contribute to the replication process. In one embodiment, the threshold value of replication time is a preset (e.g., by a database administrator) value of replication time that is used for all queries received by the DBMS 182. In another embodiment, the threshold value of replication time is based on the type of query received by the DBMS 182. In one embodiment, the replication agent 164 is configured to calculate different threshold values for different types of queries received. As an example, the query governor 186 may calculate a first threshold replication time of an UPDATE statement and a second threshold replication time for the DELETE statement. The first threshold replication time may be greater than the second threshold replication time because the system may wish to update the database more quickly for UPDATE statements rather than DELETE statements In another embodiment, the replication agent is configured to calculate different threshold values based on a time the query is received. As an example, the query governor 186 may calculate a first threshold replication time at first time (e.g., 6:00 AM) and a second threshold replication time at a second time (e.g., 3:00 PM), where the first threshold replication time is greater than the second threshold replication time. This may be due to the first time being considered a “slow” period for query processing, and a second time being considered a “busy” period for query processing. Furthermore, the above examples are for illustrative purposes only, and one of ordinary skill in the art will quickly recognize that other factors may be used for calculating the threshold amount of data change of data change as well.

If the replication agent 164 determines that the calculated replication time exceeds the threshold value, the replication agent 164 communicates with the query governor 186 to reject the query for processing. The query then rejects the received query in accordance with the instruction from the replication agent 164 (step 214). If the replication agent 164 determines that the calculated replication time does not exceed the threshold value, the replication agent 164 communicates with the query governor to begin processing the query. The query governor 186 then begins to process the received query in accordance with instructions from the replication agent 164 (step 216). Once the query is submitted for processing, or once the query governor 186 rejects the query for processing, the method 200 ends.

FIG. 2B is a flow diagram illustrating a method 250 of managing query execution, according to another embodiment of the present disclosure. At step 252, the query governor 186 receives a query for processing. The query governor may calculate an estimated replication time to replicate the data (step 256). In one embodiment, the estimated replication time is based on an estimated amount of data change for that query. The estimated amount of data change may be calculated by the query governor 186. In the embodiment shown in FIG. 2B, the query governor 186 determines the estimated replication time without having to communicate with the replication agent 164. The query governor 186 then determines whether the estimated replication time exceeds a threshold value (step 258). If the query governor 186 determines that the calculated replication time does not exceed a threshold value, the query governor 186 may process the query (step 260). If the query governor 186 determines that the calculated replication time does exceed the threshold value, the query governor 186 may reject the query for processing (step 262). Thus, the query governor 186 may carry out each step of method 200 the need to communicate with the replication agent 164. Additionally, all embodiments that follow may be practiced by the query governor 186 alone as well, without communicating with the replication agent 164.

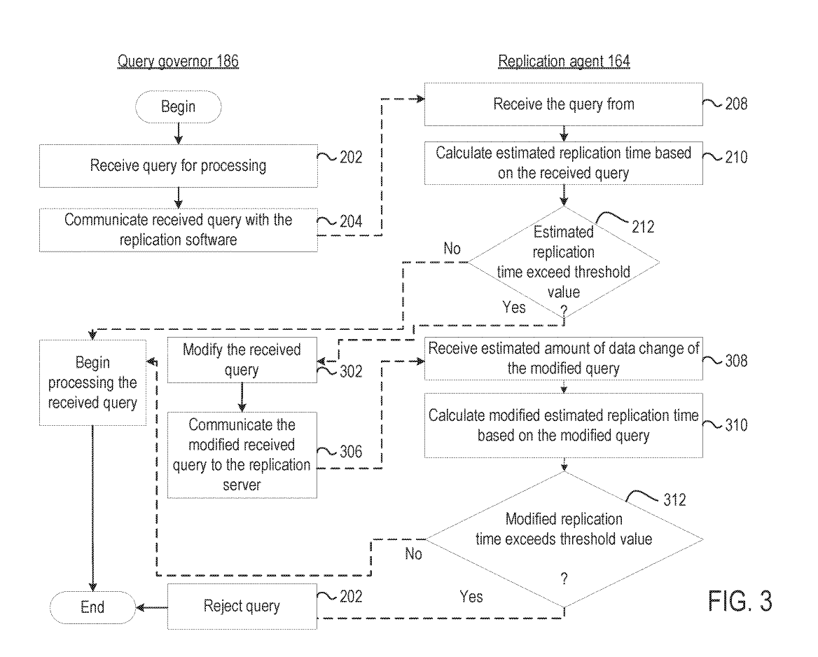

FIG. 3 is a flow diagram illustrating a method 300 of managing query execution, according to another embodiment of the present disclosure. As shown, the method 300 includes steps 202-212 from method 200. If the replication agent 164 determines that the estimated replication time exceeds the threshold value, the replication agent 164 communicates with the query governor 186 to modify the received query. In turn, the query governor 186 modifies the received query (step 302). In one embodiment, the query governor 186 may determine that the received query is equivalent to a second query that has a second estimated replication time less than the estimated replication time for the received query. As an example, the query governor 186 may determine that a query that includes a DELETE statement is equivalent to a query that includes a TRUNCATE statement, wherein the query that includes the TRUNCATE statement has a second estimated replication time less than the estimated replication time of the query that includes the DELETE statement. The query that includes the DELETE statement is equivalent to the query that includes the TRUNCATE statement with respect to modifying the data in the database. After the query governor 186 modifies the received query, the query governor 186 may communicate the modified query to the replication agent 164 to calculate an updated replication time (step 306).

The query governor 186 and the replication agent 164 may continue to communicate until a query having an estimated replication time less than the threshold replication time is found. For example, the replication agent receives the modified query from the query governor 186 (step 308). The replication agent 164 may calculate a modified estimated replication time based on the modified query (step 310). The replication agent 164 may determine if the modified replication time exceeds a threshold value (step 312). This allows the query governor 186 and the replication agent 164 to continually communicate to find a query having a replication time less than the threshold value. For example, this process may be repeated up to a threshold attempt amount of 5 times, or a desirable threshold number of attempts.

If the replication agent 164 determines that the calculated replication time does not exceed the threshold value, the replication agent 164 communicates with the query governor to begin processing the query. In turn, the query governor 186 begins to process the query (step 216). If the replication agent 164 determines that the calculated replication time does exceed the threshold value, the replication agent 164 communicates with the query governor to reject the query. In turn, the query governor 186 rejects the query (step 314). Once the query is submitted for processing or rejected, the method 300 ends.

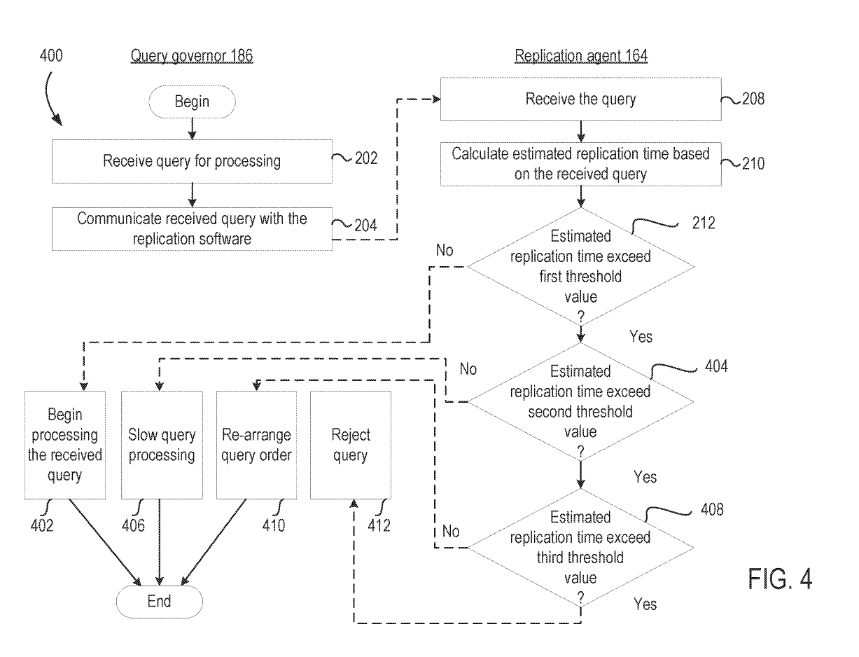

FIG. 4 is a flow diagram illustrating a method 400 of managing query execution, according to another embodiment of the present disclosure. As shown, the method 400 includes steps 202-212 from method 200. If the replication agent 164 determines that the estimated replication time does not exceed a first threshold value, then the replication agent 164 communicates with the query governor 186 to begin processing the query (step 402).

If the replication agent 164 determines that the estimated replication time exceeds a first threshold value, then the replication agent 164 determines whether the estimated replication time exceeds a second threshold value (step 404). If the replication agent determines that the estimated replication time does not exceed the second threshold value, then the replication agent 164 communicates with the query governor 186 to slow down the processing of the query. In turn, the query governor 186 slows the processing of the query so that the replication agent 164 can adequately update the changes in the database (step 406).

If the replication agent 164 determines that the estimated replication time exceeds the second threshold value, then the replication agent 164 determines whether the estimated replication time exceeds a third threshold value (step 408). If the replication agent determines that the estimated replication time does not exceed the third threshold value, then the replication agent 164 communicates with the query governor to re-arrange an order of query execution, such that the received query is executed at a later time (step 410). For example, the query governor 186 may halt execution of the query until an “off-time,” where the database in the replication agent 150 is not accessed as often.

If the replication agent 164 determines that the estimated replication time exceeds the third threshold value, then the replication agent 164 communicates with the query governor 186 to reject the query. In turn, the query governor 186 rejects the query for processing (step 412). The query governor 186 may further notify the client application 132 that submitted the query has been rejected for processing. For example, the query governor 186 may return a message to the client application 132 that submitted the query, indicating that the query was rejected for processing because of the estimated replication time is too large.

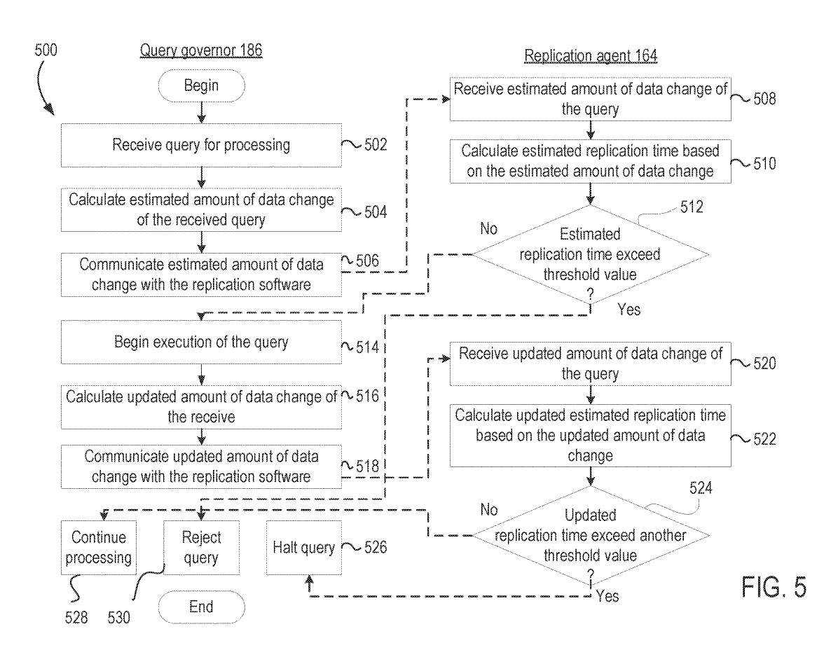

FIG. 5 is a flow diagram illustrating a method 500 of managing query execution, according to another embodiment of the present disclosure. The method begins at step 502. At step 502, the query governor 186 receives the query for processing. The query governor 186 calculates an estimated amount of data change of the received query (step 504). The query governor then communicates the estimated amount of data change with the replication agent (step 506). The replication agent 164 receives the estimated amount of data change from the query (step 508). The replication agent 164 calculates an estimated replication time based on the estimated amount of data change (step 510). The replication agent 164 determines whether the estimated replication time exceeds a threshold value. If the estimated replication time exceeds the threshold value, the replication agent 164 communicates with the query governor 186 to begin execution of the query, and the query governor 186 subsequently begins execution (step 514). After the query governor 186 begins execution of the query (step 514), the query governor 186 calculates an updated amount of data change for the query (step 516). The query governor 186 communicates the updated amount of data change to the replication agent 164.

The query governor 186 communicates the updated amount of data change with the replication agent (step 518). The replication agent 164 receives from the query governor 186 the updated amount of data change (step 520). The replication agent 164 calculates an updated replication time for replicating the data changes based on the updated amount of data change (step 522). The replication agent 164 determines whether an update replication time for replicating the data changes exceeds another threshold value (step 524). In one embodiment, the other threshold value is substantially equal to the threshold value in step 212. In another embodiment, the other threshold value is less than the threshold value in step 212. Continually comparing an updated replication time to different threshold values enhances the query management by ensuring that replication does not fall behind.

If the updated replication exceeds the other threshold value, then the replication agent 164 communicates with the query governor to halt execution of the query. In turn, the query governor 186 halts execution of the query (step 526). If the updated replication time does not exceed the other threshold value, then the replication agent communicates with the query governor 186 to continue processing of the query. In turn, the query governor continues to process the query (step 528). Once the query is submitted for processing or execution of the query is halted, the method 500 ends.

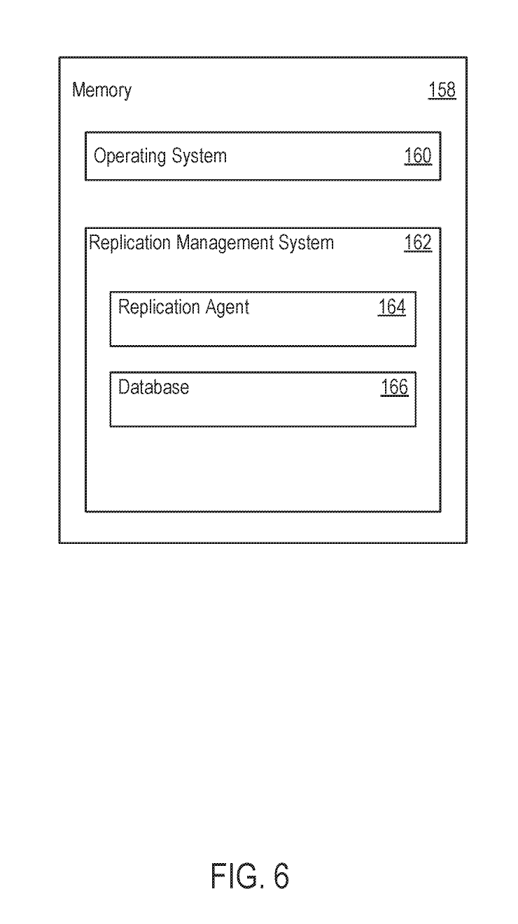

FIG. 6 is a block diagram illustrating an exemplary computer memory of the replication agent of FIGS. 1A-1B, according to one embodiment of the present disclosure. As shown, the memory 158 contains an operating system 160 and a replication management system 162. The replication management system 162 includes a replication agent 164 and a database 166. The replication management system 162 may use the replication agent 164 to calculate estimated replication times for replicating the data changes in a received query into database 166.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the present disclosure may be devised without departing from the basic scope thereof, and the scope thereof is determined by the claims that follow.

What is claimed is:

1. A method, comprising:
receiving a query to be executed against a database;
calculating an estimated replication time of the received query, wherein the estimated replication time is an estimated duration of time required to replicate changes caused by the query;
determining whether the estimated replication time exceeds a threshold replication time; and
responsive to determining that the estimated replication time does not exceed the threshold replication time, executing the query against the database in accordance with the instructions.

2. The method of claim 1, further comprising:
receiving a second query to be executed against the database;
communicating with a replication agent the received query;
receiving from the replication agent instructions to execute the second query against the database based on a determination of an estimated replication time for the second query being less than a second threshold replication time, wherein the estimated replication time for the second query is an estimated duration of time required to replicate changes caused by the second query; and
executing the second query against the database in accordance with the instructions.

3. The method of claim 2, further comprising:
receiving a third query to be executed against a database;
communicating with a replication agent, the third query;
receiving from the replication agent, instructions to modify the third query against the database based on a determination of a third estimated replication time being greater than a threshold replication time;
modifying the third query in accordance with instructions from the replication agent; and
executing the query against the database in accordance with the instructions.

4. The method of claim 3, wherein modifying the third query in accordance with instructions from the replication agent, comprises:
receiving instructions to modify the third query to an equivalent query having an estimated replication time less than the third estimated replication time of the third query.

5. The method of claim 2, further comprising:
receiving a third query to be executed against a database;
communicating with a replication agent, the third query;
receiving from the replication agent, instructions to rearrange the third query in a queue based on a determination of a third estimated replication time being greater than a threshold replication time; and
rearranging the third query in the query queue in accordance with instructions from the replication agent.

6. The method of claim 2, further comprising:
receiving a third query to be executed against a database;
communicating with a replication agent, the third query;
receiving from the replication agent, instructions to slow execution of the third query based on a determination of a third estimated replication being greater than a threshold replication time; and
slowing execution of the third query in accordance with instructions from the replication agent.

7. The method of claim 2, further comprising:
calculating an updated replication time of the second query;
communicating with a replication agent, the updated replication time;
receiving from the replication agent, instructions to execute the second query against the database based on a determination of an updated estimated replication time being less than a third threshold replication time; and
executing the second query against the database in accordance with the instructions.

8. A system, comprising:
a computer processor; and
a memory containing a program that, when executed on the computer processor, performs an operation for managing the execution of a query, comprising:
receiving a query to be executed against a database;
calculating an estimated replication time of the received query, wherein the estimated replication time is an estimated duration of time required to replicate changes caused by the query;
determining whether the estimated replication time exceeds a threshold replication time; and
responsive to determining that the estimated replication time does not exceed the threshold replication time, executing the query against the database in accordance with the instructions.

9. The system of claim 8, further comprising:
receiving a second query to be executed against the database;
communicating with a replication agent the received query;
receiving from the replication agent instructions to execute the second query against the database based on a determination of an estimated replication time for the second query being less than a second threshold replication time, wherein the estimated replication time for the second query is an estimated duration of time required to replicate changes caused by the second query; and
executing the second query against the database in accordance with the instructions.

10. The system of claim 9, further comprising:
receiving a third query to be executed against a database;
communicating with a replication agent, the third query;
receiving from the replication agent, instructions to modify the third query against the data base based on a determination of a third estimated replication time being greater than a threshold replication time;
modifying the third query in accordance with instructions from the replication agent; and
executing the query against the database in accordance with the instructions.

11. The system of claim 10, wherein modifying the third query in accordance with instructions from the replication agent, comprises:
receiving instructions to modify the third query to an equivalent query having an estimated replication time less than the third estimated replication time of the third query.

12. The system of claim 9, further comprising:
receiving a third query to be executed against a database;
communicating with a replication agent, the third query;
receiving from the replication agent, instructions to rearrange the third query in a queue based on a determination of a third estimated replication time being greater than a threshold replication time; and
rearranging the third query in the query queue in accordance with instructions from the replication agent.

13. The system of claim 9, further comprising:
receiving a third query to be executed against a database;
communicating with a replication agent, the third query;
receiving from the replication agent, instructions to slow execution of the third query based on a determination of a third estimated replication being greater than a threshold replication time; and
slowing execution of the third query in accordance with instructions from the replication agent.

14. The system of claim 8, further comprising:
calculating an updated replication time of the second query;
communicating with a replication agent, the updated replication time;
receiving from the replication agent, instructions to execute the second query against the database based on a determination of the updated estimated replication time for the amount of data change being less than a third threshold replication time; and
executing the second query against the database in accordance with the instructions.

15. A computer program product for managing the execution of a query, comprising:
a computer-readable storage medium having computer readable program code embodied therewith, the computer readable program code comprising:
computer readable program code to receive a query to be executed against a database;
computer readable program code calculate an estimated replication time of the received query, wherein the estimated replication time is an estimated duration of time required to replicate changes caused by the query;
computer readable program code to determine whether the estimated replication time exceeds a threshold replication time; and
computer readable program code to, responsive to determining that the estimated replication time does not exceed the threshold replication time, execute the query against the database in accordance with the instructions.

16. The computer program product of claim 15, further comprising:
receiving a second query to be executed against the database;
communicating with a replication agent the received query;
receiving from the replication agent instructions to execute the second query against the database based on a determination of an estimated replication time for the second query being less than a second threshold replication time, wherein the estimated replication time for the second query is an estimated duration of time required to replicate changes caused by the second query; and
executing the second query against the database in accordance with the instructions.

17. The computer program product of claim 16, further comprising:
receiving a third query to be executed against a database;
communicating with a replication agent, the third query;
receiving from the replication agent, instructions to modify the third query against the data base based on a determination of a third estimated replication time being greater than a threshold replication time;
modifying the third query in accordance with instructions from the replication agent; and
executing the query against the database in accordance with the instructions.

18. The computer program product of claim 16, further comprising:
receiving a third query to be executed against a database;
communicating with a replication agent, the third query;
receiving from the replication agent, instructions to modify the third query against the data base based on a determination of a third estimated replication time being greater than a threshold replication time;
modifying the third query in accordance with instructions from the replication agent; and
executing the query against the database in accordance with the instructions.

19. The computer program product of claim 18, wherein modifying the third query in accordance with instructions from the replication agent, comprises:
receiving instructions to modify the third query to an equivalent query having an estimated replication time less than the third estimated replication time of the third query.

20. The computer program product of claim 16, further comprising:
receiving a third query to be executed against a database;
communicating with a replication agent, the third query;
receiving from the replication agent, instructions to rearrange the third query in a queue based on a determination of a third estimated replication time being greater than a threshold replication time; and
rearranging the third query in the query queue in accordance with instructions from the replication agent.
